(19) United States
(12) Patent Application Publication
(10) Pub. No.: US 2025/0270083 A1
(43) Pub. Date: Aug. 28, 2025

(54) RETENTION ASSEMBLIES FOR MATERIAL STORAGE SYSTEMS, AND RELATED MATERIAL CONTAINERS AND METHODS

(71) Applicant: Rivian IP Holdings, LLC, Irvine, CA (US)

(72) Inventors: Kevin Karl MAYER, Costa Mesa, CA (US); Austin Lee FREDERICKSON, Carlsbad, CA (US); Nathan Philip WANG, Costa Mesa, CA (US); Abishek ANCHAN, Irvine, CA (US); Lindsey Michelle CROSS, Dana Point, CA (US); Christian V. ELDER, Irvine, CA (US); Alexander DeCastro CALACHAN, Costa Mesa, CA (US)

(21) Appl. No.: 18/590,900

(22) Filed: Feb. 28, 2024

(51) Int. Cl. B67D 1/08; B67D 1/00

(52) U.S. Cl. CPC B67D 1/0801; B67D 1/0004; B67D 2210/00136; B67D 2210/00144

(57) ABSTRACT

The present disclosure relates to retention assemblies for material storage systems, and related material containers and methods. In one or more embodiments, a retention assembly includes an actuator mounted to a retention housing, and a locking component coupled to the actuator. The actuator is movable to move the locking component between a locked position and an unlocked position. The retention assembly includes a magnet coupled to the actuator.

### INTRODUCTION

Material storage containers can be limited with respect to modularity and use. For example, it can be difficult and time consuming to refill storage containers because the storage containers can be heavy and large. Moreover, storage containers can be difficult to retain in place to prevent movement of the storage containers.

### SUMMARY

The present disclosure relates to retention assemblies for material storage systems, and related material containers and methods.

In one or more embodiments, a retention assembly includes an actuator mounted to a retention housing, and a locking component coupled to the actuator. The actuator is movable to move the locking component between a locked position and an unlocked position. The retention assembly includes a magnet coupled to the actuator.

In one or more embodiments, a material container includes a storage volume defined at least partially by a storage housing, and a nozzle pivotably coupled to the storage housing. The nozzle includes a flow housing at least partially defining an outlet opening, and a shaft coupled to the flow housing and extending into a section of the storage housing. The shaft includes a flow opening between the storage volume and the outlet opening.

In one or more embodiments, a method of using a material storage system includes moving an actuator of a retention assembly to move a locking component of the retention assembly to an unlocked position to unlock a material container retained by the retention assembly. The moving of the actuator at least partially aligns a magnet coupled to the actuator with a second magnet coupled to the material container. The method includes lifting a material container off of the retention assembly, moving the material container away from a vehicle, and dispensing a material from the material container.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting in scope, and may admit to other equally effective embodiments.

FIG. 1 is a schematic perspective view of a vehicle, according to one or more embodiments.

FIG. 2 is a schematic axonometric view of a first side of a material storage system, according to one or more embodiments.

FIG. 3 is a schematic axonometric view of a second side of the material storage system shown in FIG. 2, according to one or more embodiments.

FIG. 4 is a schematic partial cross-sectional view of the material storage system along Section 4-4 shown in FIG. 2, according to one or more embodiments.

FIG. 5 is a schematic partial bottom view of the retention assembly shown in FIGS. 2-4 with the base section hidden, according to one or more embodiments.

FIG. 6 is a schematic partial top view of the material container shown in FIGS. 2-5 with the storage housing hidden, according to one or more embodiments.

FIG. 7 is a schematic partial side view of the material storage system shown in FIGS. 1-6, according to one or more embodiments.

FIG. 8 is a schematic partial axonometric view of a nozzle, according to one or more embodiments.

FIG. 9 is a schematic cross-sectional view of the nozzle along Section 9-9 shown in FIG. 8, according to one or more embodiments.

FIGS. 10A-10D illustrate a schematic process flow of a method of using the material storage system, according to one or more embodiments.

FIG. 11 is a schematic partial side view of the retention assembly shown in FIGS. 2-10, according to one or more embodiments.

FIG. 12 is a schematic partial back view of a storage container coupled to a vehicle, according to one or more embodiments.

FIG. 13 is a schematic partial back view of the storage container shown in FIG. 12 with the one or more doors open, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to retention assemblies for material storage systems, and related material containers and methods.

In one or more embodiments, a material storage system includes a material container and a retention assembly. The material container includes a storage volume defined at least partially by a storage housing. The retention assembly is positionable to interface with the material container. The retention assembly includes an actuator mounted to a retention housing, and a locking component coupled to the actuator. The actuator is movable to move the locking component to lock and unlock the material container to and from the retention assembly. The retention assembly is operable to retain the material container when the material container is locked to the retention assembly. Additionally, the retention assembly includes a magnet coupled to the actuator, and the material container includes one or more second magnets.

The material storage system can be filled with fluid (such as liquid and/or gas), solids, and/or a combination (such as a slurry) thereof. The material storage system can store other materials. The material storage system can be connected to a spray nozzle. The fluid storage system can be used, for example, to spray off equipment and/or people (such as for cleaning and/or showering during camping), and/or to provide drinking water and/or cooking water. As described above, materials other than water may be in the material storage system. In one or more embodiments, a nozzle (e.g., a passive nozzle) is pivotably coupled to the storage housing. The nozzle includes a flow housing at least partially defining an outlet opening, and a shaft coupled to the flow housing and extending into a section of the storage housing. The shaft includes a flow opening between the storage volume and the outlet opening.

In operation, the material container can be lowered onto the retention assembly such that the material container is locked to the retention assembly using the locking component. The material container can be unlocked from the retention assembly by moving the actuator to an unlocked position. In the unlocked position, the magnet coupled to the actuator aligns with at least one of the one or more second magnets included in the material container, such that a magnetic force (e.g., an attractive force) between the magnet and the second magnet(s) maintains the actuator in the unlocked position when the actuator is released. Hence, the material container can be lifted off of the retention assembly without needing to continuously hold the actuator in the unlocked position.

The material storage system and retention assembly enable quick and easy locking and locking of a material container to and from the retention assembly. For example, the actuator can be manipulated to the unlocked position and can remove the material container from the retention assembly after releasing the actuator. Moreover, the material container can be locked to the retention assembly by lowering the material container onto the retention assembly without manipulation of the actuator. The present disclosure contemplates that the operations described herein (such as the lowering, the lifting, the unlocking, and/or the manipulation) can be conducted manually by a user and/or automatically using automated equipment.

The disclosure contemplates that terms used herein such as “couples,” “coupling,” “couple,” and “coupled” may include but are not limited to bonding, embedding, welding, fusing, melting together, interference fitting, interference abutting, and/or fastening such as by using bolts, threaded connections, pins, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links, blocks, and/or frames.

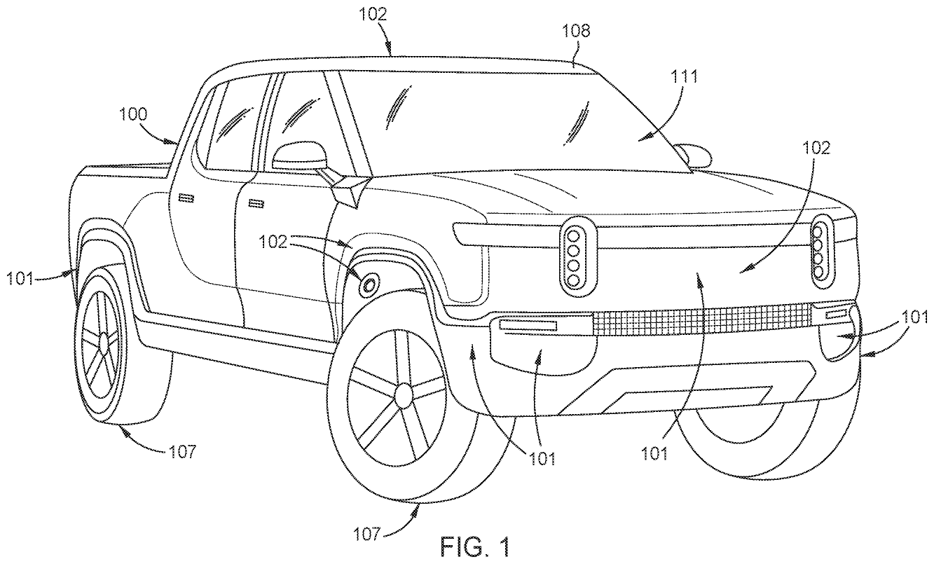

FIG. 1 is a schematic perspective view of a vehicle 100, according to one or more embodiments. The vehicle 100 may include multiple sensors 101 and/or multiple cameras 102. The vehicle 100 includes one or more wheel modules 107. The vehicle 100 is an automotive vehicle. In the implementation shown in FIG. 1, the vehicle 100 is a truck, such as an electric truck. The present disclosure contemplates that the subject matter described herein can be used in any other type of vehicle having any numbers of wheels, such as vans, internal combustion vehicles, and/or sport-utility vehicles (SUVs). The vehicle 100 includes a view panel 111 mounted to a vehicle body 108 of the vehicle 100.

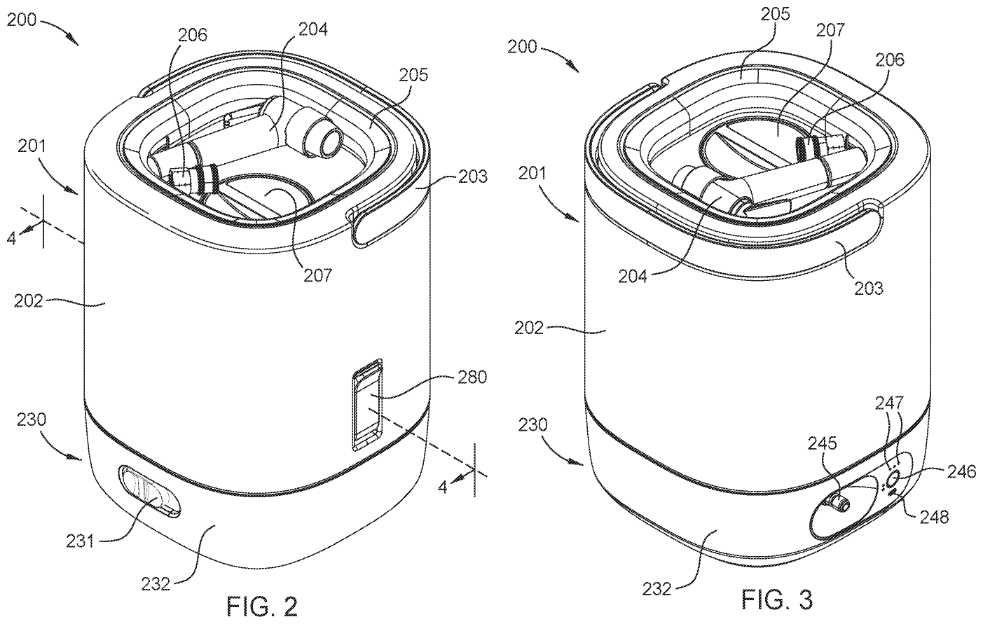

FIG. 2 is a schematic axonometric view of a first side of a material storage system 200, according to one or more embodiments. The material storage system 200 can be supported in or on a vehicle (such as the vehicle 100 shown in FIG. 1). The material storage system 200 can be supported in or on, for example, a bed, a cab, a hood, a trunk, a gear tunnel, a roof, and/or a floor of a vehicle. As another example, the material storage system 200 can be supported in or on a storage container that is supported by and/or coupled to a vehicle.

The material storage system 200 includes a material container 201 and a retention assembly 230. The material container 201 includes a storage housing 202 and a carry handle 203 coupled to the storage housing 202. FIG. 2 shows the material container 201 as locked to the retention assembly 230. The material container 201 can be locked to and unlocked from the retention assembly 230. A spray nozzle 204 and a ring 205 are supported in a recess of the storage housing 202. A hose is connected to the spray nozzle 204 and a connector 206. The hose is wound about the ring 205. A nozzle 280 is pivotably coupled to the storage housing 202. The nozzle 280 is operable to flow a material in the material container 201. The nozzle 280 is shown as disposed above the nozzle 245 of the retention assembly 230. The nozzle 280 of the material container 201 can be moved to other positions (such as above the actuator 231). The material container 201 includes a removable cap 207 coupled to the storage housing 202. The removable cap 207 can be removed such that the material container 201 can be at least partially filled with the material.

The retention assembly 230 includes an actuator 231 mounted to a retention housing 232. FIG. 2 shows the actuator 231 in a locked position that locks the material container 201 to the retention assembly 230.

FIG. 3 is a schematic axonometric view of a second side of the material storage system 200 shown in FIG. 2, according to one or more embodiments.

The retention assembly 230 includes a nozzle 245 coupled to the retention housing 232, a power button 246, one or more electrical indicators 247, and an electrical port 248. The electrical port 248 can transmit data and/or electrical power to and from the retention assembly 230. As an example, the electrical port 248 can recharge the battery 263 described below. As another example, the electrical port 248 can transmit power from the battery 263 and to a mobile device (or other equipment) such that the retention assembly 230 can be used as a power bank. The electrical port 248 can be a USB-C port. Other ports are contemplated. The retention assembly 230 can be integrated with a vehicle (such as the vehicle 100) such that electrical power and/or data can be supplied from the power system of the vehicle and to the retention assembly 230 through the electrical port 248. The nozzle 245 is operable to flow the material in the material container 201. In one or more embodiments, the nozzle 245 of the retention assembly 230 is an active nozzle, and the nozzle 280 of the material container 201 is a passive nozzle.

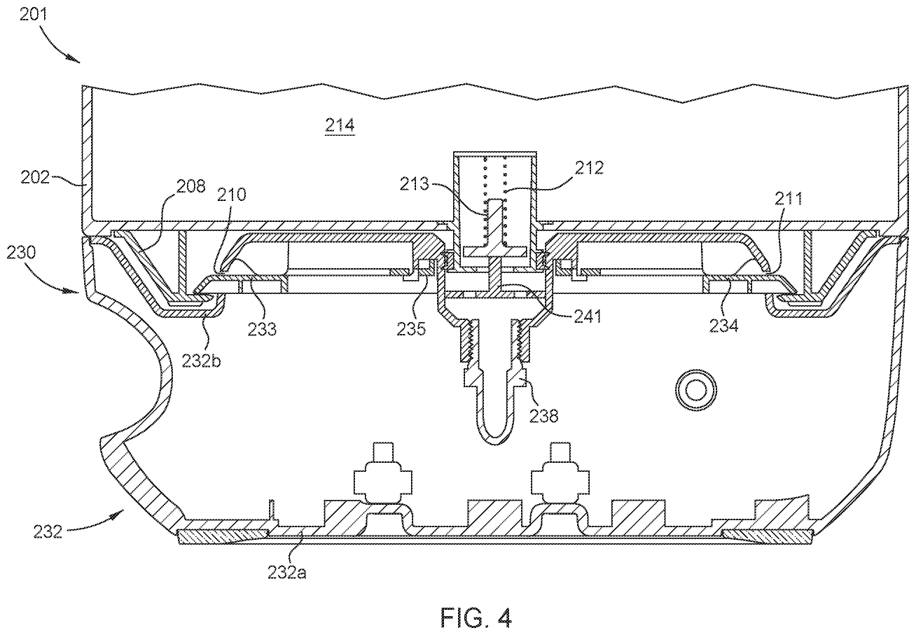

FIG. 4 is a schematic partial cross-sectional view of the material storage system 200 along Section 4-4 shown in FIG. 2, according to one or more embodiments.

The retention assembly 230 includes a locking component 233 and a second locking component 234 coupled to the actuator 231. The actuator 231 is movable to move the locking component 233 and the second locking component 234 between the locked position and an unlocked position. The retention assembly 230 includes a rotatable link 235 pivotably coupled to the locking component 233 and the second locking component 234. In one or more embodiments, the retention housing 232 includes a base section 232a and a lid section 232b coupled together. The material container 201 includes an extension 208 extending relative to the storage housing 202, an opening 210 formed in the extension 208, and a second opening 211 formed in the extension 208. The actuator 231 is movable to move the locking component 233 into and out of the opening 210. The actuator 231 is also movable to move the second locking component 234 into and out of the second opening 211. FIG. 4 shows the locking components 233, 234 in the locked position with the locking components 233, 234 extending respectively into the openings 209, 210. The actuator 231 can be moved to the unlocked position such that the locking components 233, 234 are retracted respectively out of the openings 209, 210. The storage housing 202 at least partially defines a storage volume 214 that is at least partially filled with the material.

The retention assembly 230 includes a column 241 disposed in a conduit 238. The conduit 238 is fluidly connected to the nozzle 245 (shown in FIG. 3) of the retention assembly 230. When the material container 201 is lowered onto the retention assembly 230, the extension 208 pushes on angled (e.g., tapered) or curved outer surfaces of the locking components 233, 234 to push the locking components 233, 234 toward the rotatable link 235 until the locking components 233, 234 can move into the openings 210, 211 and into the locked position. Also, when the material container 201 is lowered, the column 241 pushes a plunger 212 against a bias element 213 to move the plunger 212 upward. The movement of the plunger 212 allows the material in the material container 201 to flow past the plunger 213, through the conduit 238, and out through the nozzle 245.

In one or more embodiments, the actuator 231 includes a toggle button, the locking component 233 includes a first striker, the second locking component 234 includes a second striker, and/or the rotatable link 235 includes a pawl. FIG. 4 shows the nozzle 280 schematically and without hatching.

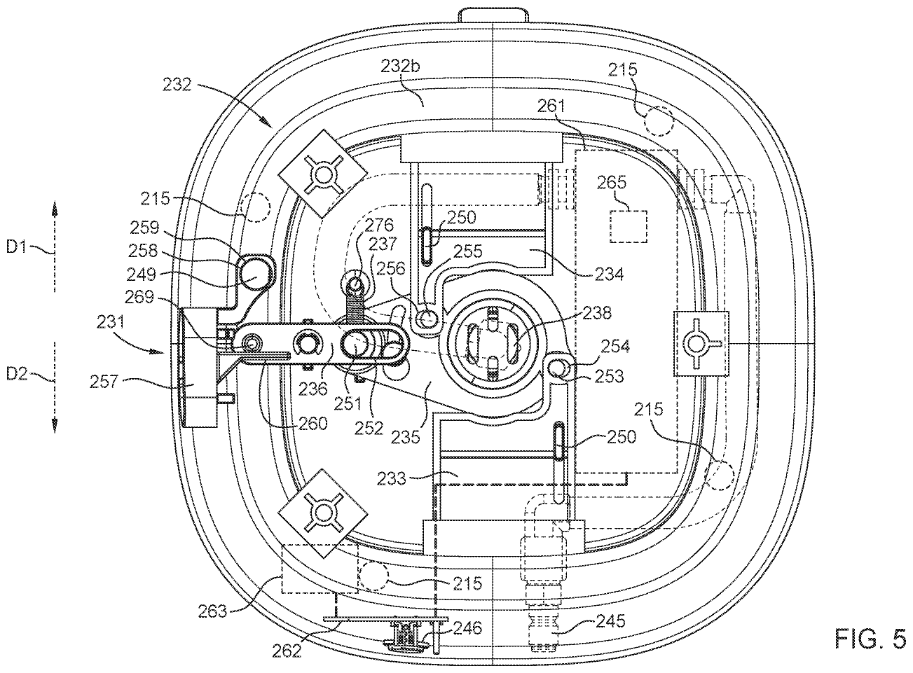

FIG. 5 is a schematic partial bottom view of the retention assembly 230 shown in FIGS. 2-4 with the base section 232a hidden, according to one or more embodiments. The retention assembly 230 includes a magnet 249 coupled to the actuator 231, and a transfer link 236 coupled between the rotatable link 235 and the actuator 231. The rotatable link 235 is rotatable relative to the retention housing 232 and the storage housing 202. The transfer link 236 is pivotable relative to the rotatable link 235 and the actuator 231 such that when the actuator 231 moves the transfer link 236 pivots to rotate the rotatable link 235. The rotation of the rotatable link 235 moves the locking components 233, 234. In one or more embodiments, the locking components 233, 234 are plates. The rotatable link 235 includes an extension 251 extending into an opening 252 of the transfer link 236.

First extensions 250 of the lid section 232b extend into channels formed in the locking components 233, 234 to guide the locking components 233, 234 as the locking components 233, 234 extend toward the locked position and retract toward the unlocked position. The retention assembly 230 includes a bias element 237 operable to bias the actuator 231 toward the locked position. In one or more embodiments, the bias elements 213, 237 respectively include a spring, such as a coil spring, for example a helical coil spring. The bias elements 213, 237 can respectively be tape springs, wave springs, torsion springs, and/or flat springs. Other springs and/or other bias elements are contemplated. In one or more embodiments, the bias element 237 is under compression and expands to bias the actuator 231 to the locked position. The bias element 237 is coupled to the extension 251 of the rotatable link 235 and a second extension 276 of the lid section 232b. The magnet 249 is configured resist the bias element 237 to hold the actuator 231 in the unlocked position when an accessory (such as the material container 201) is positioned on the retention assembly 230.

The locking component 233 interfaces with a first side of the rotatable link 235, and the second locking component 234 interfaces with a second side of the rotatable link 235, the second side opposing the first side. The rotatable link 235 includes a second extension 253 extending into an opening 254 of the locking component 233, and a third extension 255 extending into a second opening 256 of the second locking component 234.

The actuator 231 includes a handle 257 and a receptacle 258 having an opening 259. The magnet 249 is disposed in the opening 259. In one or more embodiments, the magnet 249 is bonded (e.g., glued) to the actuator 231. The actuator 231 is coupled to the transfer link 236 using a flange 260 abutting against a protrusion 269 of the transfer link 236. The retention assembly 230 includes a pump 261 (shown in ghost for visual clarity purposes) fluidly connected to the nozzle 245, a controller 262 in communication with the pump 261, and a battery 263 (shown in ghost for visual clarity purposes) electrically connected to the controller 262. The controller 262 can include, for example, a memory and/or a processor. The controller 262 can include a printed circuit board (PCB). The pump 261 is an electric pump 261. The pump 261 pressurizes the material to pump the material through the nozzle 245 and the spray nozzle 204. The material storage system 200 can include one or more heat transfer elements 265 operable to heat and/or cool the material. The one or more heat transfer elements 265 can, for example, be coupled to the retention assembly 230 (such as coupled to the pump 261) to heat and/or cool the material as the material is dispensed and/or be coupled to the material container 201 to heat and/or cool the material as the material is stored in the material container 201.

The material container 201 includes one or more second magnets 215 (a plurality, e.g., four, are shown). As the actuator 231 moves (e.g., along a first direction D1) to the locked position, the magnet 249 aligns under one of the second magnets 215 to generate and/or increase an attractive magnetic force between the magnet 249 and the respective second magnet 215. In one or more embodiments, the magnet 249 and the one or more second magnets 215 are ferromagnetic. The attractive magnetic force is sufficient to overcome a bias force of the bias element 237 to maintain the actuator 231 in the locked position after the handle 257 is released by a user and/or automated equipment, which allows the material container 201 to be lifted off of the retention assembly 230 without continued manipulation of the handle 257. During the lifting of the material container 201, the respective second magnet 215 is moved away from the magnet 249 by a sufficient distance to reduce or eliminate the attractive magnetic force. When the attractive magnetic force is reduced or eliminated, the bias force of the bias element 237 moves the actuator 231 (e.g., along a second direction D2) back to the locked position shown in FIG. 5. The bias element 237 biases the locking component 233 toward the opening 210 (see FIG. 4) of the material container 201 and biases the second locking component 234 toward the second opening 211 (see FIG. 4) of the material container 201.

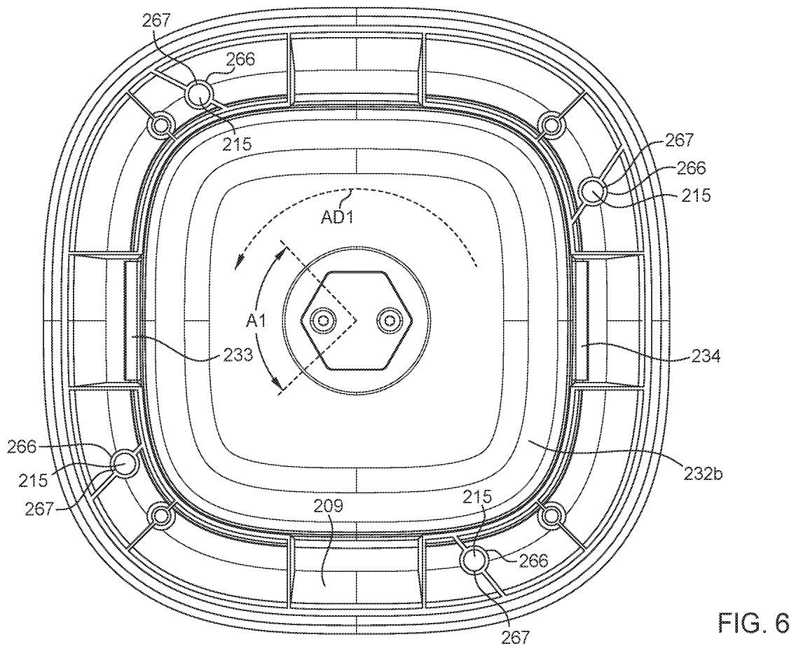

FIG. 6 is a schematic partial top view of the material container 201 shown in FIGS. 2-5 with the storage housing 202 hidden, according to one or more embodiments.

The one or more second magnets 215 are respectively disposed in opening(s) 267 of one or more protrusions 266 of the extension 208. In one or more embodiments, the respective second magnets 215 are bonded (e.g., glued) to the one or more protrusions 266. The second magnets 215 are spaced from each other along an azimuthal direction AD1. The second magnets 215 are spaced equidistantly from each other by an azimuthal angle A1 such that, if the material container 201 is rotated, the magnet 249 aligns with at least one of the one or more second magnets 215 when in the locked position. In one or more embodiments, the azimuthal angle A1 is about 90 degrees.

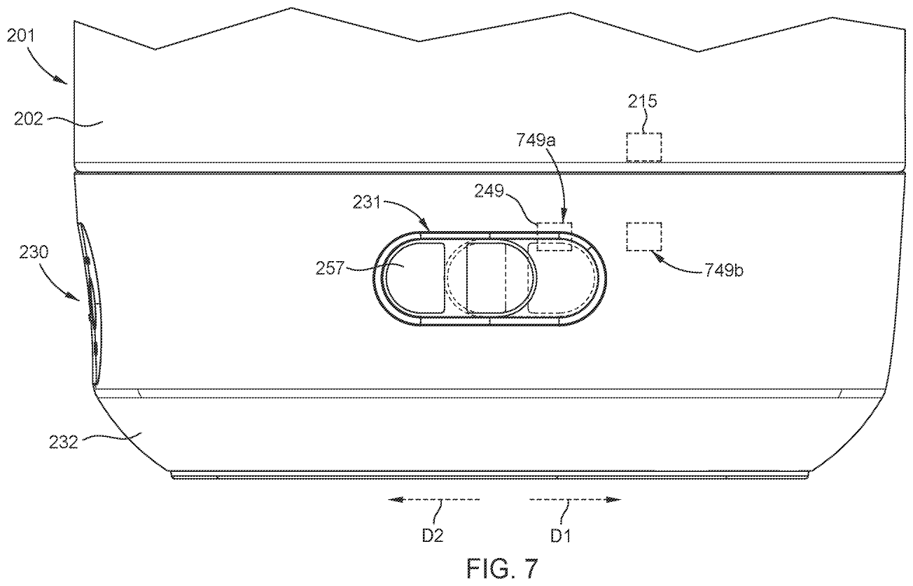

FIG. 7 is a schematic partial side view of the material storage system 200 shown in FIGS. 1-6, according to one or more embodiments.

FIG. 7 shows the actuator 231 in solid in the locked position, and in ghost in the unlocked position. The magnet 249 (shown in ghost) moves between a first position 749a in the locked position and a second position 749b in the unlocked position. In the locked position, the magnet 249 is offset from the respective second magnets 215. In the unlocked position, the magnet 249 is at least partially aligned under at least one of the second magnets 215.

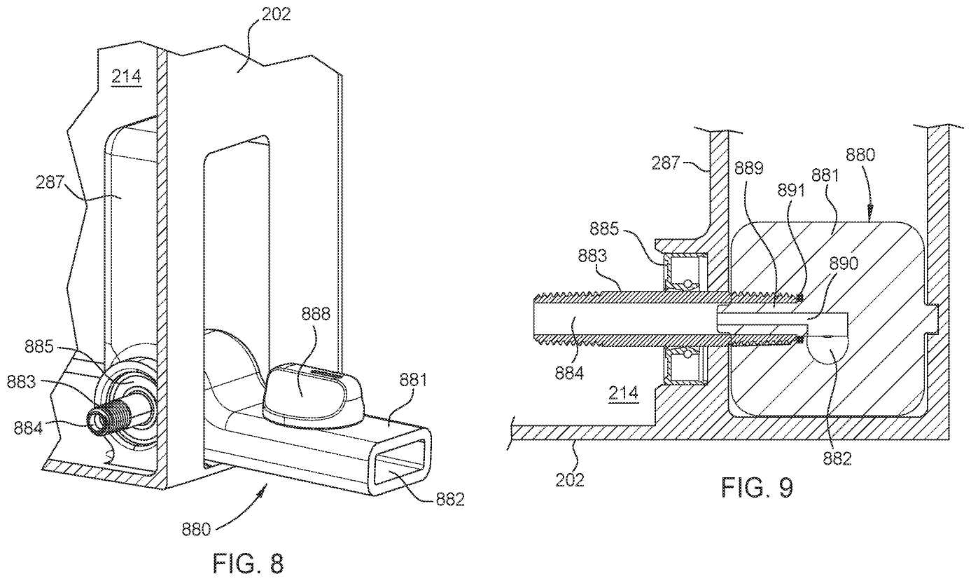

FIG. 8 is a schematic partial axonometric view of a nozzle 880, according to one or more embodiments. The nozzle 880 can be used in place of the nozzle 280 of the material container 201 shown in FIGS. 2 and 4.

FIG. 2 shows the nozzle 280 in a collapsed position, and FIG. 8 shows the nozzle 880 pivoted into an extended position. The nozzle 880 includes a flow housing 881 at least partially defining an outlet opening 882. The nozzle 880 includes a shaft 883 coupled to the flow housing 881 and extending into a section 287 of the storage housing 202. In one or more embodiments, the shaft 883 extends through the section 887 of the storage housing 202 and into the storage volume 214. The shaft 883 includes a flow opening 884 between the storage volume 214 and the outlet opening 882. A washer seal 885 is disposed about the shaft 883 of the nozzle 880. The shaft 883 is rotatable relative to the storage housing. The nozzle 880 includes a valve 888 coupled to the flow housing 881. The valve 888 can be, for example, an air return valve. Other types of valves are contemplated.

FIG. 9 is a schematic cross-sectional view of the nozzle 880 along Section 9-9 shown in FIG. 8, according to one or more embodiments.

In one or more embodiments, the shaft 883 is threaded into the flow housing 881 and is disposed about a rod section 889 of the flow housing 881. An opening 890 of the rod section 889 fluidly connects the flow opening 884 of the shaft 883 to the outlet opening 882. A second washer seal 891 is disposed about the rod section 289. The rod section 889, the shaft 883, and the flow housing 881 can move (e.g., rotate) together. The rod section 889 can be integrally formed with the flow housing 881 or can inserted into (e.g., threaded into) the flow housing 881. The second washer seal 891 is disposed between the flow housing 881 and an end of the shaft 883.

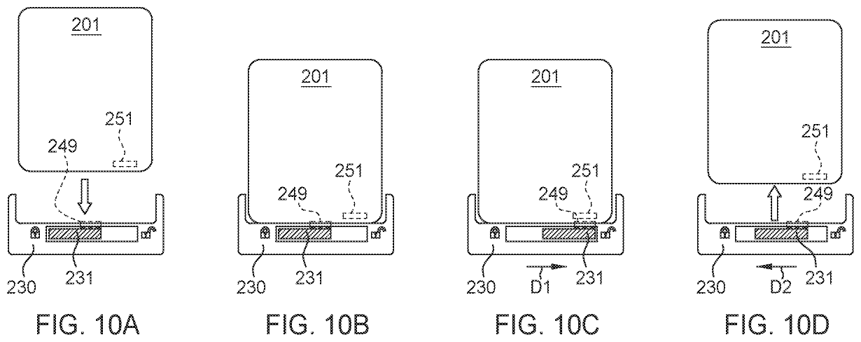

FIGS. 10A-10D illustrate a schematic process flow of a method of using the material storage system 200, according to one or more embodiments.

The description of the method includes references to reference numerals of the material storage system 200, and the present disclosure contemplates that subject matter (such as structures and components) other than the subject matter of the material storage system 200 can be used in relation to the method.

At FIG. 10A, the retention assembly 230 is shown with the actuator 231 in the locked position. The material container 201 is positioned in relation to (e.g., above) the retention assembly 230.

At FIG. 10B, the material container 201 is positioned (e.g., lowered) to interface with the retention assembly 230 to lock the material container 201 to the retention assembly 230.

At FIG. 10C, the method includes moving the actuator 231 to move the locking component 233 and the second locking component 234 to the unlocked position to unlock the material container 201 retained by the retention assembly 230. The moving of the actuator 231 at least partially aligns the magnet 249 coupled to the actuator 231 with at least one of the second magnet 215 coupled to the material container 201.

At FIG. 10D, the material container 201 is lifted off of the retention assembly 230. The method can include moving the material container 201 away from a vehicle (such as the vehicle 100). The lifting of the material container 201 moves the at least one second magnet 215 away from the magnet 249 to bias the actuator 231 to the locked position. FIG. 10D shows the actuator 231 as the actuator 231 is automatically biased toward the locked position.

The method can include dispensing the material from the material container 201. For example, the material can be dispensed using the nozzle 280 and/or the nozzle 880 of the material container 201. As another example, the material can be dispensed using the nozzle 245 of the retention assembly 230 when the material container 201 is interfacing with the retention assembly 230 (e.g., in FIG. 10B and/or FIG. 10C). The method can include connecting (e.g., using the connector 206) the spray nozzle 204 to the nozzle 245 of the retention assembly 230 prior to the dispensing of the material.

In one or more embodiments, the method includes at least partially filling the storage volume 214 of the material container 201 with the material before FIG. 10A and/or after FIG. 10D when the material container 201 is lifted off of the retention assembly 230. After the storage volume 214 is at least partially filled, the material container 201 can be lowered and/or re-lowered (as shown in FIG. 10B) onto the retention assembly 230 to lock the material container 201 to the retention assembly 230.

When the fill level of the material container 201 is low, the material container 201 can be removed from the retention assembly 230 (as shown in FIG. 10D), and a second material container 201 (e.g., having a higher fill level) can be lowered and locked to the retention assembly 230 (as shown in FIG. 10B).

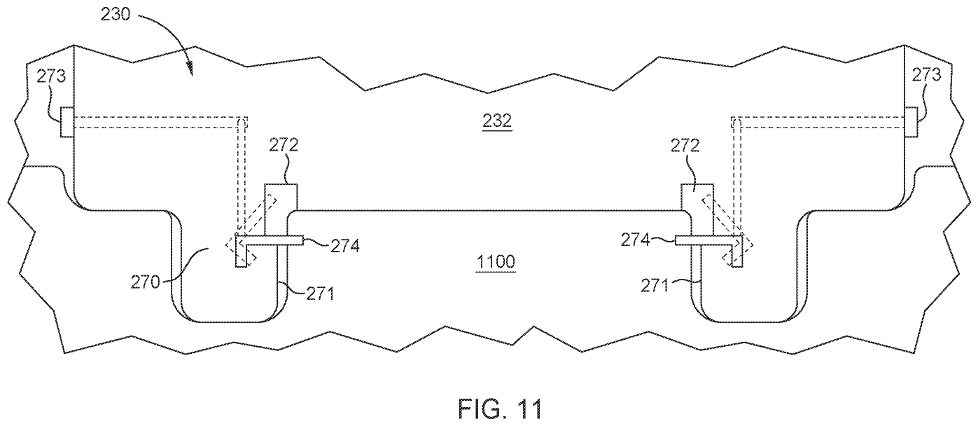

FIG. 11 is a schematic partial side view of the retention assembly 230 shown in FIGS. 2-10, according to one or more embodiments.

The retention assembly 230 is coupled to a vehicle panel 1100 of a vehicle. The retention assembly 230 includes an extension 270 including an outer surface 271 and at least one opening 272 formed in the outer surface 271. The present disclosure contemplates that the extension 270 can be separated into a plurality of extensions. The retention assembly 230 includes at least one second actuator 273 mounted to the retention housing 232, and at least one third locking component 274 disposed in the at least one opening 272 and coupled to the at least one second actuator 273.

The at least one second actuator 273 is movable to move the at least one third locking component 274 between a first position (shown in solid in FIG. 11) and a second position (shown in ghost in FIG. 11). In the first position, the at least one third locking component 274 is at least partially outside of the at least one opening 272 and abutting against the vehicle panel 1100. In the second position the at least one third locking component 274 is moved into the at least one opening 272 relative to the first position. The implementation in FIG. 11 shows two third locking components 274 and two second actuators 273. The respective second actuators 273 are rotatable to pivot the respective third locking components 274 between the first position and the second position. In the first position, the third locking components 274 extend into one or more openings of the vehicle panel 1100 to lock the retention assembly 230 to the vehicle panel 1100. The second actuators 273 can include cams having key slots such that a key can be used to turn the second actuators 273 and lock the third locking components 274 in the first position or the second position. The present disclosure contemplates that the second actuators 273 can include pivotable bars. The vehicle panel 1100 can be disposed along a bed, a cab, a hood, a trunk, a gear tunnel, a roof, and/or a floor of a vehicle. As another example, the vehicle panel 1100 can be disposed along a storage container that is supported by and/or coupled to a vehicle.

The retention assembly 230 can be movable relative to a vehicle (as shown in FIGS. 2-10) or locked in place relative to the vehicle (as shown in FIG. 11). The retention housing 232 can be integrally formed with the vehicle panel 1100.

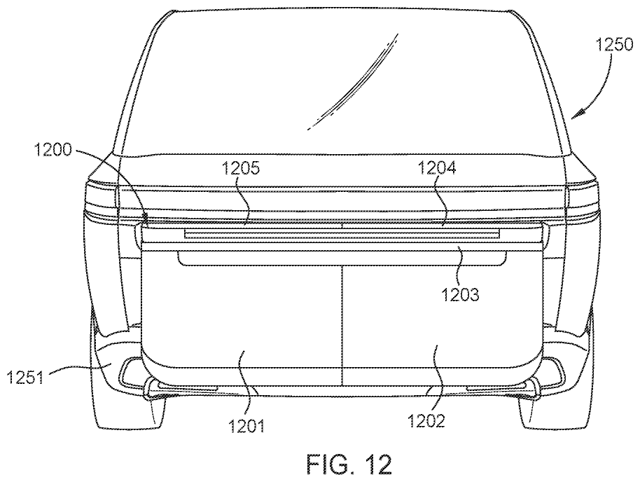

FIG. 12 is a schematic partial back view of a storage container 1200 coupled to a vehicle 1250, according to one or more embodiments. The storage container 1200 can be attached, for example, to a rear bumper 1251 of the vehicle 1250. The vehicle 1250 is shown as an SUV. Other vehicles are contemplated.

The storage container 1200 includes one or more doors 1201, 1202 (two are shown) a roof 1203, and a bench 1204. The bench 1204 can include a cook top 1205 (such as a stove top). The bench 1204 can be omitted and/or the roof 1203 can be moved to provide access inside of the storage container 1200. The one or more doors 1201, 1202 can be opened e.g., pivoted) to provide access inside of the storage container 1200. The present disclosure contemplates that the one or more doors 1201, 1202 can be replaced with stationary wall(s). One or more support bars can be coupled to the storage container 1200 and the vehicle 1250 such that the vehicle 1250 supports the storage container 1200. The one or more support bars can extend at least partially between the vehicle 1250 to space the storage container 1200 from the vehicle 1250.

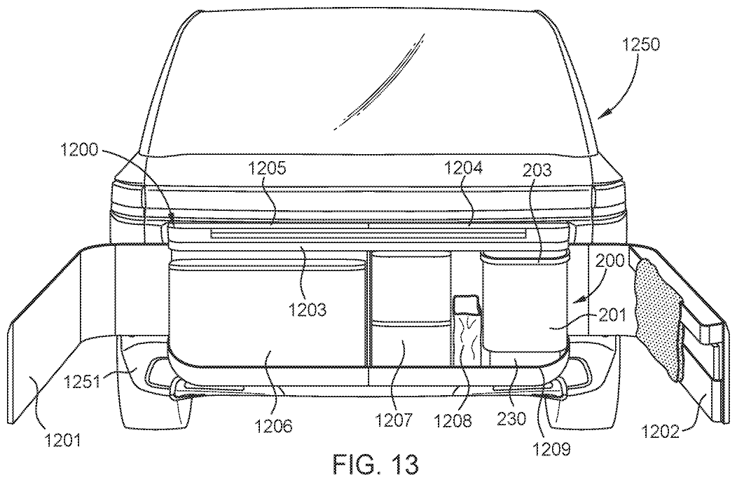

FIG. 13 is a schematic partial back view of the storage container 1200 shown in FIG. 12 with the one or more doors 1201, 1202 open, according to one or more embodiments.

A cooler 1206, a trash container 1207, an equipment container 1208 (containing, e.g., pots and pans and/or kitchen utensils), and/or the material storage system 200 can be stored in the storage container 1200. The doors 1201 can also hold equipment (such as cooking ingredients, kitchen utensils, and/or other equipment). The retention assembly 230 is coupled to a floor 1209 of the storage container 1200. The retention housing 232 can be integrally formed floor 1209. The vehicle panel 1100 described in relation to FIG. 11 can be part of the floor 1209, and the retention assembly 230 can be removably locked to the floor 1209 in a manner—for example—described in relation to FIG. 11. Although not shown in FIG. 13, the present disclosure contemplates that the actuator 231, the nozzle 245, the nozzle 280 (and/or the nozzle 880), the power button 246, the one or more electrical indicators 247, and/or the electrical port 248 can be positioned for easy access (as an example, facing door 1202) when the material container 201 is locked to the retention assembly 230 inside of the storage container 1200. Other positions and/or orientations are contemplated for the actuator 231, the nozzle 245, the nozzle 280 (and/or the nozzle 880), the power button 246, the one or more electrical indicators 247, and/or the electrical port 248.

Benefits of the present disclosure include but are not limited to ease and simplicity of mechanically locking and automatically mechanically (e.g., magnetically) unlocking of material containers to and from retention assemblies; smaller and/or lighter material containers for easy and quick refilling; and reliable retention of storage containers to reduce or eliminate movement of the storage containers.

It is contemplated that one or more aspects disclosed herein may be combined. As an example, one or more aspects, features, components, operations and/or properties of the vehicle 100, the material container 201, the retention assembly 230, the nozzle 280, nozzle 880, the method shown in FIGS. 10A-10D, the retention assembly 230 implementation shown in FIG. 11, the vehicle panel 1100, and/or the storage container 1200 may be combined. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

What is claimed is:

1. A retention assembly, comprising:
an actuator mounted to a retention housing;
a locking component coupled to the actuator, the actuator movable to move the locking component between a locked position and an unlocked position; and
a magnet coupled to the actuator.

2. The retention assembly of claim 1, further comprising a bias element operable to bias the actuator toward the locked position, wherein the magnet is configured resist the bias element to hold the actuator in the unlocked position when an accessory is positioned on the retention assembly.

3. The retention assembly of claim 1, further comprising:
a rotatable link pivotably coupled to the locking component; and
a transfer link coupled between the rotatable link and the actuator.

4. The retention assembly of claim 3, wherein the rotatable link is rotatable relative to the retention housing, and the transfer link is pivotable relative to the rotatable link and the actuator.

5. The retention assembly of claim 3, wherein the rotatable link comprises an extension extending into an opening of the transfer link.

6. The retention assembly of claim 3, wherein:
the locking component interfaces with a first side of the rotatable link;
the retention assembly further comprises a second locking component interfacing with a second side of the rotatable link, the second side opposing the first side; and
the rotatable link comprises an extension extending into an opening of the locking component.

7. The retention assembly of claim 3, wherein the actuator comprises:
a handle;
a receptacle having an opening, wherein the magnet is disposed in the opening; and
a flange abutting against the transfer link.

8. The retention assembly of claim 1, wherein the retention assembly comprises:
an extension comprising an outer surface and an opening formed in the outer surface;
a second actuator mounted to the retention housing; and
a second locking component disposed in the opening and coupled to the second actuator.

9. The retention assembly of claim 8, wherein the second actuator is movable to move the second locking component between a first position in the opening and a second position, wherein in the second position the second locking component is at least partially outside of the opening and abutting against a vehicle panel.

10. A material storage system, comprising:
a material container comprising a storage volume defined at least partially by a storage housing; and
the retention assembly of claim 1, wherein the material container is positionable to interface with the retention assembly, and the locking component moves between the locked position and the unlocked positon to lock and unlock the material container to and from the retention assembly.

11. The material storage system of claim 10, wherein:
the material container further comprises:
one or more second magnets,
an extension extending relative to the storage housing, and
an opening formed in the extension, wherein the actuator is movable to move the locking component into and out of the opening; and
the retention assembly further comprises:
a bias element operable to bias the locking component toward the opening.

12. The material storage system of claim 10, wherein the retention assembly further comprises:
a nozzle operable to flow a material;
a pump fluidly connected to the nozzle;
a controller in communication with the pump; and
a battery electrically connected to the controller.

13. A material container, comprising:
a storage volume defined at least partially by a storage housing; and
a nozzle pivotably coupled to the storage housing, the nozzle comprising:
a flow housing at least partially defining an outlet opening, and
a shaft coupled to the flow housing and extending into a section of the storage housing, the shaft comprising a flow opening between the storage volume and the outlet opening.

14. The material container of claim 13, further comprising a washer seal disposed about the shaft of the nozzle, wherein the shaft is rotatable relative to the storage housing.

15. The material container of claim 13, wherein the nozzle further comprises a valve coupled to the flow housing.

16. A method of using a material storage system, comprising:
moving an actuator of a retention assembly to move a locking component of the retention assembly to an unlocked position to unlock a material container retained by the retention assembly, the moving of the actuator at least partially aligning a magnet coupled to the actuator with a second magnet coupled to the material container;
lifting a material container off of the retention assembly;
moving the material container away from a vehicle; and
dispensing a material from the material container.

17. The method of claim 16, wherein the retention assembly is coupled to a vehicle panel of the vehicle.

18. The method of claim 16, wherein the lifting of the material container moves the second magnet away from the magnet to bias the actuator to a locked position, and the method further comprises:
at least partially filling a storage volume of the material container with the material.

19. The method of claim 18, further comprising lowering the material container onto the retention assembly to lock the material container to the retention assembly.

20. The method of claim 16, further comprising connecting a spray nozzle to a nozzle of the retention assembly.
